(19) United States
(12) Patent Application Publication
(10) Pub. No.: US 2023/0404045 A1
(43) Pub. Date: Dec. 21, 2023

(54) METHOD FOR THE POLYCULTURE OF CLAMS WITH OYSTERS

(71) Applicant: Morgan State University, Baltimore, MD (US)

(72) Inventor: Ming Liu, California, MD (US)

(21) Appl. No.: 18/210,986

(22) Filed: Jun. 16, 2023

Related U.S. Application Data
(60) Provisional application No. 63/352,821, filed on Jun. 16, 2022.

(51) Int. Cl. A01K 61/55; A01K 61/60

(52) U.S. Cl. CPC A01K 61/55; A01K 61/60

(57) ABSTRACT

A method for polycultivating clams with oysters in subtidal zones in an oyster growing-out bag at a low density, then placing the bags in the upper layer of the water by floating system including floating cage or floats. The clam could be Mya arenaria, and all other economic bivalve species that require burrowing in sand to ensure their growth.

### FIELD OF THE INVENTION

This invention relates to methods for the culturing of clams.

### BACKGROUND OF THE INVENTION

The soft-shell clam Mya arenaria (hereinafter referred to as Mya) is a commercially important bivalve inhabiting intertidal and subtidal zones along the U.S. east coast, primarily from Maine to Maryland. Between 2016 and 2019, U.S. commercial harvest ranged from 2.5 million lbs and 3.0 million lbs, with dockside values between $20.7 and $26.0 million dollars. The vast majority of harvest (>90%) was in two states—Maine (about 64% of total harvest) and Massachusetts (about 27%). In contrast, Maryland harvest was about 5% of the total, with an annual average harvest of about 174,000 lbs and a dockside value of about $1.3 million annually (NOAA Fisheries, 2021).

The Maryland Mya industry has been subject to a great deal of variability, both historically as well as within the more recent time period described above. Dating back to the 1950s, '60s and early '70s, Maryland led the U.S. in Mya harvest with an average of 3.6 million lbs/yr and maintained a reduced harvest that still exceeded 1 million lbs/yr through the early 1990s. Harvest was nearly non-existent during 2012-2013 (less than 2,000 lbs of reported harvest each year), while in 2016 harvest exceeded 300,000 lbs (NOAA Fisheries, 2021). Reduced and highly variable harvests are suspected to be caused by cumulative stresses of habitat loss, overfishing, destructive equipment types, invasive predators and disease pressure.

As an economically valuable shellfish species native to the Maryland portion of the Chesapeake Bay, it is perhaps surprising that the potential to culture Mya in Maryland waters has not been rigorously explored. This is especially true given that Maryland's current aquaculture industry relies exclusively on oysters, and that the hard clams (Mercenaria mercenaria) extensively farmed in Virginia Chesapeake Bay waters are not viewed as a viable alternative given low tolerance for low salinity waters. While the Maryland oyster aquaculture industry has exhibited 24% annual growth since 2012 (van Senten et al., 2019), the lack of diversity in Maryland aquaculture is increasingly noted as an impediment to sustainable industry growth and resilience.

Regardless of the current yield of Mya, the historical high abundance and naturally occurring populations suggest that low-salinity waters in the Maryland portion of the Chesapeake Bay are a suitable environment for Mya culture. Mya tolerates a wide range of salinities (4 to 33 ppt, Weston et al., 2010), with normal growth and reproduction in low salinities of <10 ppt. In contrast, these low salinities can be fatal to oyster larvae by causing abnormal embryo development (Calabrese and Davis, 1970), and can slow growth and increase mortality of juvenile/adult oysters (Shumway, 1996). In particular, the Maryland oyster industry suffered significant financial impacts in 2018 and 2019 due to a prolonged low salinity event caused by record levels of rainfall. Although salinity levels have now returned to normal, a freshet recurrence is still a concern amongst the industry. The characteristic of low-salinity adaptiveness of Mya enables it to generate stable revenue with limited impact from low salinity environments compared with oysters and other economically important shellfish that require higher salinity waters.

While market demand and environmental suitability are evidence of the potential for a viable Mya aquaculture industry, innovative grow-out methods plus reliable seed production are required to transform this potential into a reality. Traditional Mya aquaculture is sand-based due to their burrowing characteristics, and employ an intertidal netting method, in which Mya seed are planted in-situ, often covered by a protective netting to exclude predators, with net maintenance and harvesting activity scheduled to coincide with exposure during low tides. This method has been widely adopted in the New England region; however, the Maryland current aquaculture area is mainly located in the Chesapeake Bay side where there is a lack of intertidal zones. The intertidal netting method cannot be used in subtidal waters. Therefore, development of a suitable subtidal culture method is the key to the successful launch of this new aquaculture in Maryland.

### SUMMARY OF THE INVENTION

The invention is a Mya subtidal culture method enabling faster growth and providing effective protection from predators at low-cost with easy operation, with an aim of adding Mya as an economically viable option for commercial aquaculture in Maryland.

The invention presents a sand-free and off-bottom polyculture method that puts Mya seed with oyster juveniles (less than one year old) in common oyster growing-out bags at a certain density for each species and places the growing-out bags in a floating cage. Alternatively, floats may be added to the growing-out bags themselves. The use of a floating system ensures a good water flow-through, and therefore provides more algae food, better water quality, and less biofouling, which are critical to Mya and oyster growth.

The floating polyculture method of the invention is expected to lead to a significant improvement in clam culture in the subtidal region, especially in Maryland, where the current aquaculture only relies on a single species—the eastern oysters. It will also enable growers to culture the economical bivalve species, such as soft-shell clams, hard shell clams, surf clams and razor clams using their current oyster utilization without additional input cost in subtidal region other than Maryland.

The key techniques for the inventive method are:
a. placing clams along with oysters in standard oyster grow-out equipment (FIGS. 1 and 2), where both clam and oyster can grow normally with a high survival rate;
b. using floating grow-out equipment to enable the fastest animal growth (FIGS. 3 and 4);
c. using juvenile oysters that are less than one year old at a recommended initial density of 100 per bag for both oysters and clams; and
d. using an initial deployment bag of 2 mm in size bag, then transferring them to 6 mm and/or 9 mm bags (FIG. 1) as the clams grow, enabling sufficient water flow through.

The key advantages of this method are:
a. enabling clams to grow normally: the soft-shell clams usually grow in the sand, and the field test data showed they can also grow well in a sand-free and well water flow-through environment;
b. cost savings: the clams grown with oysters (polyculture) showed faster growth rate as compared to the clams grown alone without oysters (monoculture) in a floating environment; the oysters also showed an equal growth rate as compared to oyster monoculture. This means than a current oyster grower can start culturing clam by using their existing equipment without additional space and equipment;
c. easy operation: the growing equipment can be easily accessed as current oyster growers do for their oysters; there is no need to add sand, diving, or use a crane as with other clam culture methods;
d. Very effective protection from predators: compared to sand-based methods, this method has very high survival rates, and the equipment isn't destroyed by water currents or predators, such as crabs and otters.

Accordingly, there is provided according to the invention a method for cultivating clams comprising: placing clam seed in a mesh bag with live juvenile oysters, placing the mesh bag containing clam seed and live juvenile oysters in a floating system so that the mesh bag is held under the surface of the water. The clam seed are preferably selected from the group consisting of Mya arenaria, razor clam, hard clam, and Atlantic surf clam. Most preferably, the clam seed is Mya. The mesh bag should be maintained at 1 inch to 48 inches under the surface of the water, alternatively at 2 inches to 36 inches under the surface of the water, and further alternatively at 6 inches to 24 inches under the surface of the water. The preferred mesh bag is an oyster grow-out bag. The ratio of clam seed to oysters may be 74:100 to 100:300, more preferably 100:75 to 100:300, and most preferably 1:1. The method preferably takes place in a subtidal zone of a brackish estuary, preferably a Maryland portion of the Chesapeake Bay, and the mesh bag is preferably contained in a floating oyster cage or is directly held by floats. The oysters are preferably less than one year old at an initial culture time. The method is preferably carried out where water salinity is in the range of 2 ppt to 30 ppt, preferably in the range of 4 ppt to 20 ppt, and most preferably in the range of 6 ppt to 15 ppt.

The invention summarized above may be better understood by referring to the following description, claims, and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

### BRIEF DESCRIPTION OF DRAWINGS

FIG. 1 is an illustration of Mya seed placed in an oyster grow-out bag.

FIG. 2 shows a 3×2 cell bottom cage used to hold the grow-out bags according to embodiments of the invention.

FIG. 3 shows an oyster cage with a float attached.

FIG. 4 shows floating cages and floating bags according to an embodiment of the invention.

FIG. 5 shows an example of a soft bag loaded with clam seeds.

FIG. 6 is a chart showing clam shell length at the end of a growth period using different culture methods.

FIG. 7 is a chart showing oyster and clam grown in monoculture and polyculture.

FIG. 8 is a chart showing survival rate of clams at the end of a growth period using different culture methods.

### DETAILED DESCRIPTION OF THE INVENTION

Experiment 1: To test if the sand-free off-bottom polyculture method of the invention can facilitate Mya growth and ensure a high survival rate, a field test was performed between the polyculture method of the invention and two other methods, a. the soft-bag on-bottom culture, and b. the sand-tray on-bottom culture.

The soft-bag on-bottom culture is a common method that is often used in hard clam aquaculture. The clam seed are put in a large soft mesh bag (FIG. 5) then the bags are fixed on the water bottom. The bags protect clams from predators and prevent clams from moving to other places. Sediment in the water gradually gathers and covers the top of the bags to create a simulated burying-into-sediment environment. Given that both hard clam and soft-shell clam require burrowing themselves into sand to ensure growth, it seemed likely that this hard clam culture method might also be suitable for the soft-shell clam culture. The advantages are that this method is easy to deploy and harvest, and the bags are in an acceptable price range. For this experiment, the soft bag on bottom was used with clams only (monoculture).

The sand-tray on-bottom culture uses a tray for holding sand. The clam seed is placed in the sand and a net is used to cover the top of the tray to protect the clams from predators. This method has been used in some sand-needed bivalve subtidal aquaculture trials, but has not been popularized because a tray made strong enough to hold the large amount of sand required for makes this method costly and difficult to operate. Additionally, the top cover can be easily destroyed by predators or strong water currents.

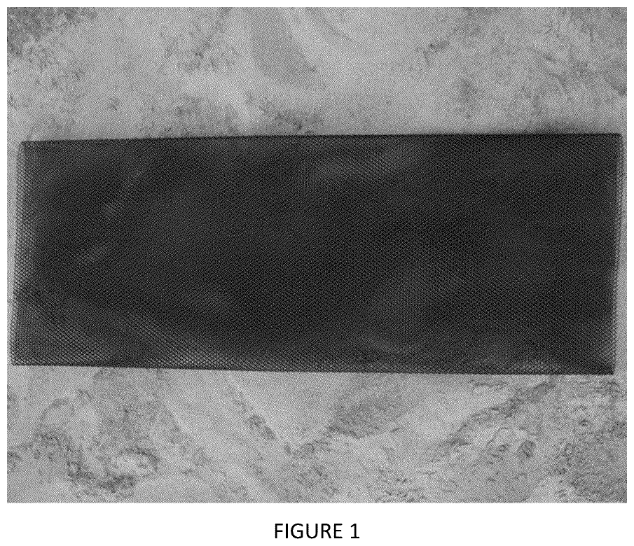

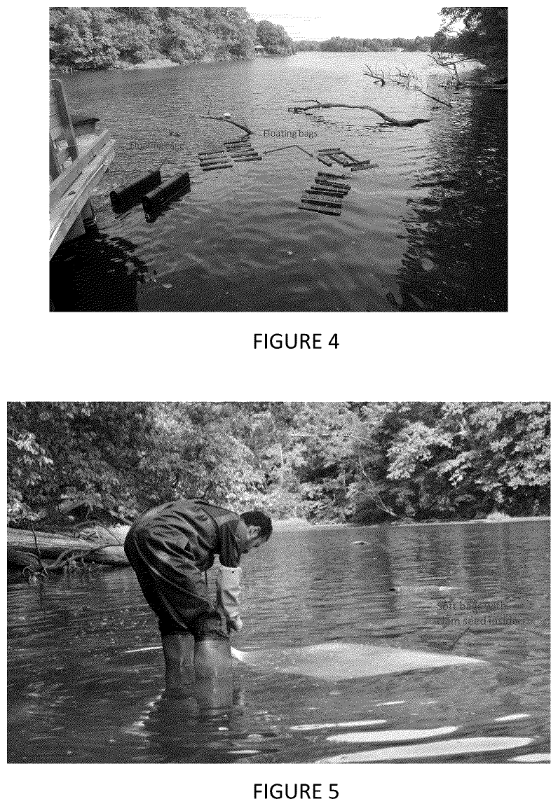

Experiment 2: To examine if both Mya and oyster grow normally in a floating polyculture method, the same polyculture equipment (FIGS. 1-4) were also used for Mya monoculture and oyster monoculture as controls in the field test.

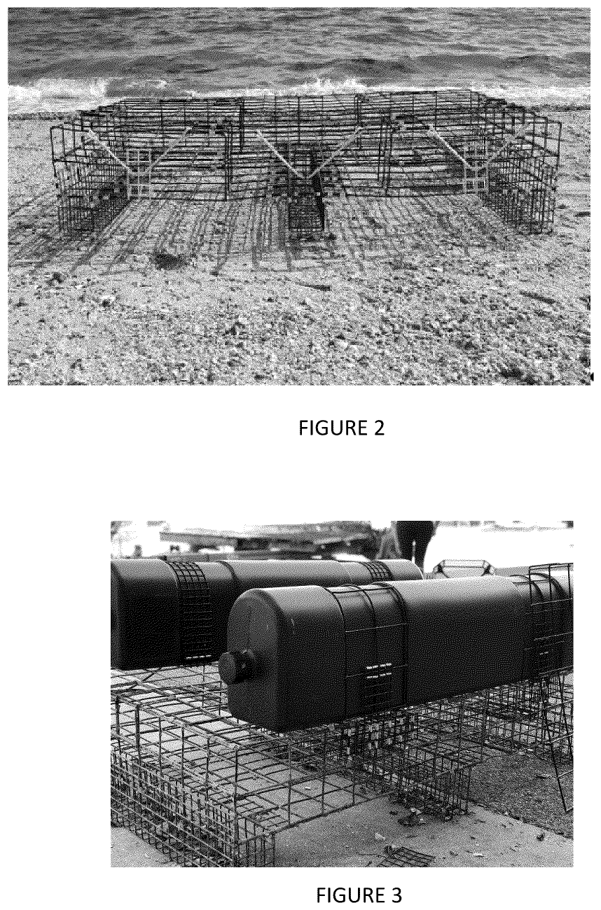

Experiment 3: To determine what water layer (upper or bottom) that the polyculture generates the faster Mya and oyster growth, a comparison was also made between floating polyculture and on-bottom polyculture method. The on-bottom polyculture used the same bags and cage (FIGS. 1 and 2) that were used for the floating polyculture but without the floats, so they were placed on the water bottom.

All the experiments 1-3 were conducted synchronously, enabling comparisons with each other. The Mya seed used was produced by Morgan State University's Patuxent Environmental Area Research Laboratory (“PEARL”) aquaculture team using Maryland local wild broodstock. The initial Mya density for all methods was 100 per bag/tray. The initial oyster density in polyculture or monoculture was 100 per bag as well. The average Mya shell length was obtained by randomly measuring 100 Mya and oysters before deployment. All methods employed at least three replicates. The cultures were all deployed at the end of October 2022. The cultures were collected in early June 2023. The shell length and survival rate were examined to evaluate the performance of each culture method. The results are shown in Table 1.

TABLE 1

| | | Clam | Average | Clam | | |
|---|---|---|---|---|---|---|
| | | Shell | Shell | sur- | Average | Oyster |
| Culture | Repli- | Length | Length | vival | survival | survival |
| methods | cate | (mm) | mm | % | % | % |
| Soft-bag | 1 | 27.2216 | | 65 | | |
| on-bottom | 2 | 28.3612 | | 61 | | |
| culture | 3 | 26.9932 | 27.52533 | 66 | 64.00 | |
| Floating | 1 | 30.7294 | | 94 | | |
| monoculture | 2 | 29.0802 | | 97 | | |
| | 3 | 29.6678 | 29.8258 | 98 | 96.33 | |
| Floating | 1 | 32.09327 | | 96 | | 97 |
| polyculture | 2 | 30.9369 | | 100 | | 95 |
| | 3 | 30.87583 | 31.302 | 100 | 98.67 | 89 |
| On-bottom | 1 | 26.3434 | | 99 | | |
| monoculture | 2 | 28.1538 | | 94 | | |
| | 3 | 26.3944 | 26.96387 | 100 | 97.67 | |
| On-bottom | 1 | 24.9416 | | 95 | | 100 |
| polyculture | 2 | 25.0896 | | 92 | | 96 |
| | 3 | 24.5378 | 24.85633 | 97 | 94.67 | 100 |
| Sand-tray | 1 | 31.9432 | | 88 | | |
| on-bottom | 2 | 31.5858 | | 92 | | |
| culture | 3 | 30.9866 | 31.5052 | 76 | 85.33 | |

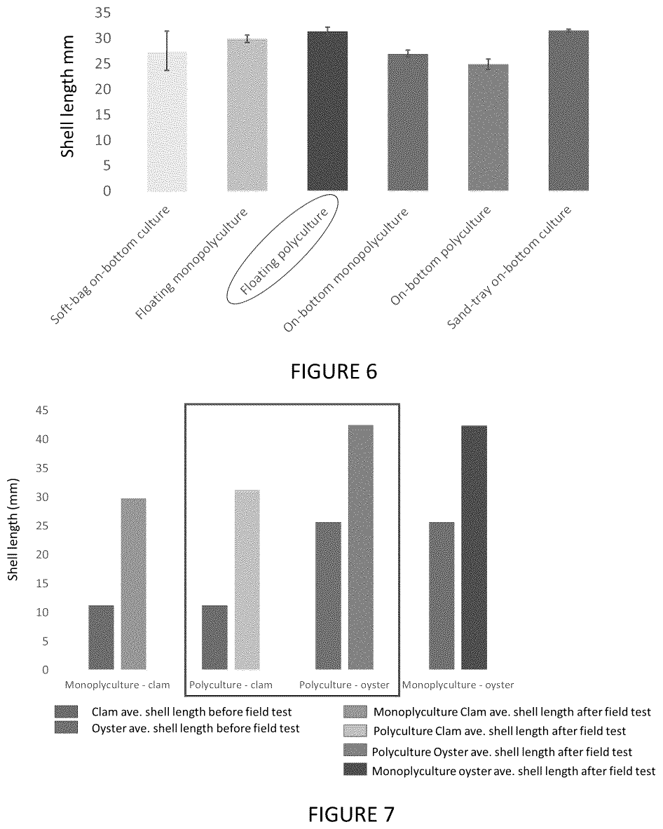

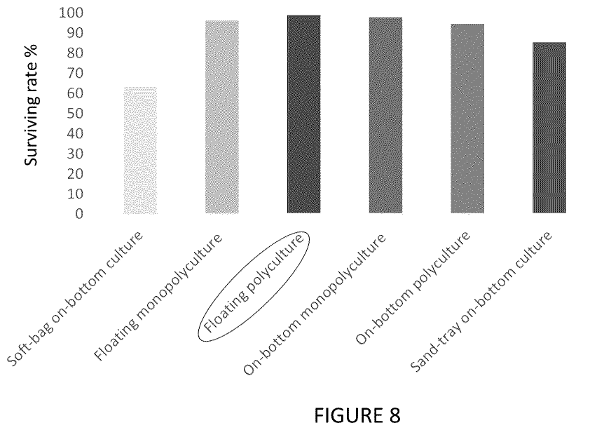

The results showed Mya grew faster in both sand-tray and floating polyculture methods, compared to other tested methods (Table 1 and FIG. 6). The average shell lengths in the sand-tray and floating polyculture methods were quite similar (31.05 mm and 31.03 mm) after an about 7.5 month field culture (Table 1). The floating polyculture had the highest survival rate, and all the polyculture methods, both floating and on-bottom, had high survival rates compared to other methods (Table 1 and FIG. 8).

While the Mya in sand-tray culture showed strong growth, this method requires the purchase or fabrication of heavy duty sand trays and the use of large amounts of sand that may lead to high costs. Additionally, the deployment and harvesting of the trays is difficult because the sand-laden trays are very heavy, especially after being immersed in the water for several months. And the protective net cover on the top of the sand tray is also easily destroyed by large predators or strong water currents that will cause a loss of the cultured Mya.

The Mya in floating polyculture grow a little bit faster than a Mya monoculture, and the oysters in polyculture have the equivalent growth with the oyster monoculture in the same equipment (Table 1 and FIG. 7). This indicates in a limited farm space, polyculture can output both oysters and clams that will double growers' profit without purchasing new equipment.

The floating polyculture showed faster growth rate compared to the on-bottom polyculture (Table 1 and FIG. 8). That suggest floating polyculture should be used to ensure the fastest growth.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept.

1. A method for cultivating clams comprising: placing clam seed in a mesh bag with live juvenile oysters, placing the mesh bag containing clam seed and live juvenile oysters in a floating system so that the mesh bag is held under the surface of the water.

2. The method of claim 1, wherein the clam seed are selected from the group consisting of Mya arenaria, razor clam, hard clam, and Atlantic surf clam.

3. The method of claim 1, wherein the clam seed is Mya.

4. The method of claim 1, wherein the mesh bag is maintained at 1 inch to 48 inches under the surface of the water.

5. The method of claim 1, wherein the mesh bag is maintained at 2 inches to 36 inches under the surface of the water.

6. The method of claim 1, wherein the mesh bag is maintained at 6 inches to 24 inches under the surface of the water.

7. The method according to claim 1, wherein the mesh bag is an oyster grow-out bag.

8. The method according to claim 1, wherein the ratio of clam seed to oysters is 74:100 to 100:300.

9. The method according to claim 1, wherein the ratio of clam seed to oysters is 100:75 to 100:300.

10. The method according to claim 1, wherein the ratio of clam seed to oysters is 1:1

11. The method according to claim 1, taking place in a subtidal zone.

12. The method according to claim 1, wherein the mesh bag is contained in a floating oyster cage or is directly held by floats.

13. The method according to claim 1, wherein the juvenile oysters are less than one year old at an initial culture time.

14. The method according to claim 1, taking place in a subtidal zone in a Maryland portion of the Chesapeake Bay.

15. The method according to claim 1, wherein water salinity is in the range of 2 ppt to 30 ppt.

16. The method according to claim 1, wherein water salinity is in the range of 4 ppt to 20 ppt.

17. The method according to claim 1, wherein water salinity is in the range of 6 ppt to 15 ppt.

18. The method according to claim 1, taking place in brackish water of an estuary.
